(19) United States
(12) Patent Application Publication
(10) Pub. No.: US 2008/0020731 A1
(43) Pub. Date: Jan. 24, 2008

(54) Accounting method and system in a communication system

(75) Inventors: Jae-Young Kim, Yongin-si (KR); Han-Seok Kim, Seoul (KR); Jae-Woo Kwon, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/827,825

(22) Filed: Jul. 13, 2007

(30) Foreign Application Priority Data
Jul. 18, 2006 (KR) 66920/2006

(51) Int. Cl. H04M 1/66

(52) U.S. Cl. 455/407

(57) ABSTRACT

An accounting method in a communication system. In the accounting method, a base station (BS) allocates resources to a mobile station (MS) located in its own cell according to data that the BS will exchange with the MS, exchanges data with the MS over the allocated resources, and then performs accounting according to allocation information of the allocated resources.

### CROSS-REFERENCE TO RELATED APPLICATION(S) AND CLAIM OF PRIORITY

This application claims the benefit under 35 U.S.C. § 119(a) of a Korean Patent Application filed in the Korean Intellectual Property Office on Jul. 18, 2006 and assigned Serial No. 2006-66920, the disclosure of which is incorporated herein by reference.

### TECHNICAL FIELD OF THE INVENTION

The present application relates generally to a communication system, and in particular, to an accounting method and system for an uplink in a communication system.

### BACKGROUND OF THE INVENTION

Intensive research in the next generation communication system is being conducted to provide users with high-speed services having various Quality-of-Service (QoS) classes. A communication system, when a base station (BS) transmits/receives data to/from a mobile station (MS), records accounting (or charging) based on a packet size of the transmitted/received data, and transmits the accounting record to an accounting server, thereby charging the corresponding MS. With reference to FIG. 1, a description will now be made of an accounting system in a communication system.

FIG. 1 is a schematic diagram illustrating a configuration of an accounting system in a communication system.

Referring to FIG. 1, the accounting system includes a BS 110 for exchanging data packets with MSs, a policy server 120 for storing QoS profile information of the MSs, and an accounting server 130 for managing accounting for the data packets exchanged with the MSs.

More specifically, a signaling block 114 of the BS 110 acquires QoS profile information of the MSs, stored in an MS QoS profile database 124 of the policy server 120, via a signaling interface 122 of the policy server 120, generates a database for the MSs according to the acquired information, and stores the database in an MS database 116. A traffic block 112 of the BS 110 processes the data packets exchanged with the MSs according to the database of MSs, stored in the MS database 116, and records accounting information for the transmitted data packets every time the transmission of the data packets is completed. Thereafter, the signaling block 114 of the BS 110 stores the recorded accounting information in the accounting database 134 of the accounting server 130 via the signaling interface of the accounting server 130, and charges the MSs according to the stored accounting information.

The accounting scheme in the communication system, as described above, charges corresponding MSs according to a size of data packets exchanged between the MSs and the BS, i.e., according to a size of data packets processed and transmitted by the traffic block 112 of the BS 110, making it difficult to guarantee accurate accounting for the corresponding MSs. For example, an Institute of Electrical and Electronics Engineers (IEEE) 802.16 communication system allocates resources so that MSs may send a request for resource allocation to a BS for data transmission, and a scheduler of the BS may allow the MSs to transmit data to the BS in response to the request. In this case, the BS uniquely allocates resources to a corresponding MS so that for data transmission, only the corresponding MS can use the resources allocated thereto, i.e., other MSs except for the corresponding MS cannot use the resources.

Therefore, when the MS allocated resources from the BS does not use all of the resources allocated thereto for data transmission, the accounting scheme in the communication system may charge even for the used resources. Specifically, the accounting scheme may charge even for the used resources, (i) when the MS transmits a less amount of data than the amount of data corresponding to the resources that it has requested for data transmission, (ii) when the MS transmits no data, or (iii) when the MS transmits data of a lower QoS class than the QoS class of the data corresponding to the resources that it has requested for data transmission of a high QoS class. As a result, the accounting scheme in the communication system may not guarantee substantially accurate accounting for the MSs, and may cause a decrease in economical utilization of the resources.

### SUMMARY OF THE INVENTION

To address the above-discussed deficiencies of the prior art, it is a primary object to provide at least the advantages described below. Accordingly, an aspect of the present invention is to provide an accounting method and system in a communication system.

Anther aspect of the present invention is to provide an accounting method and system for correctly charging MSs that transmit/receive data in a communication system.

According to one aspect of the present invention, there is provided an accounting method in a communication system. The accounting method includes allocating, by a base station (BS), resources to a mobile station (MS) located in its own cell according to data that the BS will exchange with the MS; and exchanging data with the MS over the allocated resources, and performing accounting according to allocation information of the allocated resources.

According to another aspect of the present invention, there is provided an accounting system in a communication system. The accounting system includes a base station (BS) in charge of a particular cell, for allocating resources to a mobile station (MS) located in the cell according to data that the BS will exchange with the MS, exchanging data with the MS over the allocated resources, and then performing accounting according to allocation information of the allocated resources.

According to another aspect of the present invention, there is provided an accounting system in a communication system. The accounting system includes a mobile station, a base station (BS) capable of communicating with the mobile stations, wherein the base station includes a scheduler for allocating resources to the mobile station according to an amount and a quality-of-service (QoS) class according to data that the base station will exchange with the mobile station a data processor for processing the data that the base station will exchange with the mobile station and data that the base station has exchanged with the mobile station through the allocated resources, an accounting part for accounting according to process of the scheduler and the data processor.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following detailed description when taken in conjunction with the accompanying drawings, in which like reference numerals represent like parts:

FIG. 1 is a schematic diagram illustrating a configuration of an accounting system in a communication system;

FIG. 2 is a schematic diagram illustrating a configuration of an accounting system in a communication system according to an embodiment of the present invention;

FIG. 3 is a schematic diagram illustrating a structure of a BS for accounting in a communication system according to an embodiment of the present invention;

FIG. 4 is a diagram for a description of accounting by a BS in a communication system according to an embodiment of the present invention;

FIG. 5 is a flowchart illustrating a process of generating accounting information by a BS in a communication system according to an embodiment of the present invention;

FIG. 6 is a schematic signaling diagram illustrating signal exchange between a BS and an accounting server in a communication system according to an embodiment of the present invention; and

FIG. 7 is a flowchart illustrating an accounting operation of an accounting server in a communication system according to an embodiment of the present invention.

### DETAILED DESCRIPTION OF THE PREFERRED EMBODIMENTS

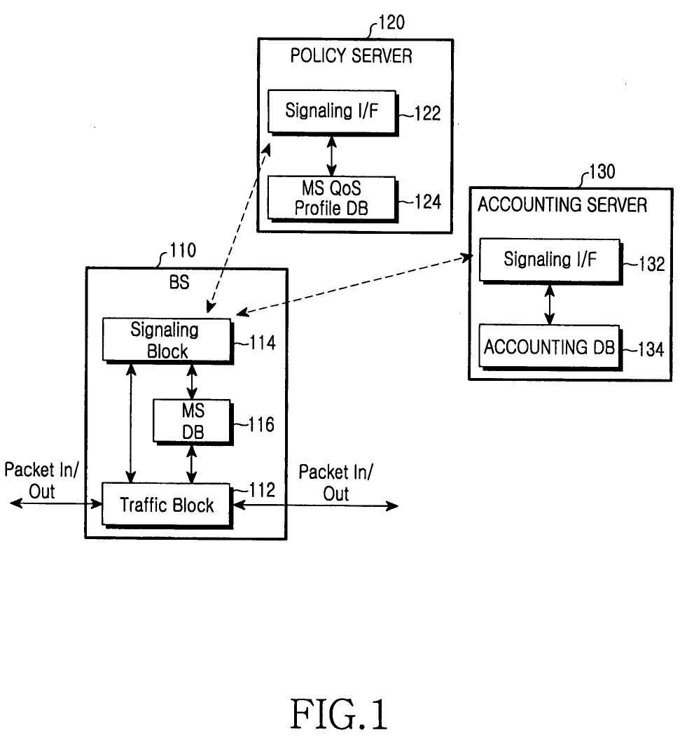

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will now be described in detail with reference to the annexed drawings. In the following description, a detailed description of known functions and configurations incorporated herein has been omitted for clarity and conciseness.

The present invention provides an accounting method and system in a communication system, for example, an Institute of Electrical and Electronics Engineers (IEEE) 802.16 communication system, which is a Broadband Wireless Access (BWA) communication system. Although an embodiment of the present invention will be described herein with reference to an IEEE 802.16 communication system employing Orthogonal Frequency Division Multiplexing (OFDM)/Orthogonal Frequency Division Multiple Access (OFDMA), by way of example, the accounting method and system provided by the present invention can also be applied to other communication systems, for example, Code Division Multiple Access (CDMA), Frequency Division Multiple Access (FDMA), and Time Division Multiple Access (TDMA) communication systems.

In addition, the present invention provides, in a communication system, an accounting method and system for charging for the data exchanged between a base station (BS) in charge of a particular cell and a mobile station (MS) that is located in the particular cell and receives a communication service from the BS. Although an embodiment of the present invention, described below, provides an accounting method and system for uplink data transmission from an MS, receiving a communication service from a BS in charge of a particular cell, to the BS in an OFDM/OFDMA communication system, it can also be applied to downlink data transmission from the BS to the MS. According to the present invention, when a BS exchanges data with an MS, the BS performs accounting (or charging) according to an amount of resources that it has allocated to the MS for the uplink/downlink data exchange.

An embodiment of the present invention, described below, provides herein an accounting method and system in which a serving BS in charge of a particular cell charges for transmission data of an MS in an OFDM/OFDMA communication system. The serving BS, when an arbitrary MS located in its serving cell transmits uplink data, charges the MS for the data transmission according to the resources that the MS has requested for its data transmission to the BS, i.e., according to allocation information of the resources that the serving BS has allocated to the MS, depending on an amount of transmission data desired by the MS and a Quality-of-Service (QoS) class of the desired transmission data.

In addition, when transmitting downlink data to an arbitrary MS, the serving BS charges the MS for the data transmission according to allocation information of the resources that it has allocated to the MS depending on an amount and a QoS class of the transmission data. For uplink service accounting for the MS, the serving BS charges the MS by taking into account not only the allocation information of the resources allocated to the MS, but also use information of the resources used for data transmission by the MS, for example, use information of the resources used depending on an amount and a QoS class of the data received from the MS.

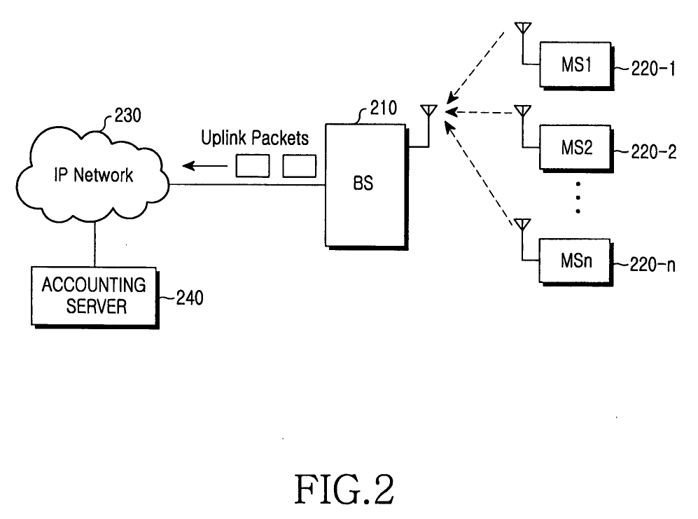

With reference to FIG. 2, a description will now be made of an accounting system in a communication system according to an embodiment of the present invention. FIG. 2 is a schematic diagram illustrating a configuration of an accounting system in a communication system according to an embodiment of the present invention.

Referring to FIG. 2, the accounting system includes a BS 210 for receiving uplink data packets from a plurality of MSs, i.e., MS1 220-1, MS2 220-2 and MSn 220-n, an Internet Protocol (IP) network 230 for receiving the received uplink data packets from the BS 210, and an accounting server 240 for managing accounting for a corresponding MS that has transmitted the uplink data packets.

The BS 210, as described above, charges the MSs 220-1, 220-2 and 220-n according to the resources that the MS1 220-1, MS2 220-2 and MSn 220-n have requested for transmission of uplink data packets, i.e., according to allocation information of the resources that the BS 210 has allocated to the MSs 220-1, 220-2 and 220-n depending on an amount and a QoS class of the data packets to be transmitted by the MS1 220-1, MS2 220-2 and MSn 220-n. The BS 210 can charge the MSs 220-1, 220-2 and 220-n not only according to the allocation information of the allocated resources, but also according to use information of the allocated resources, for example, use information of the resources used depending on an amount and a QoS class of uplink data packets which are received from the MSs 220-1, 220-2 and 220-n over the allocated resources.

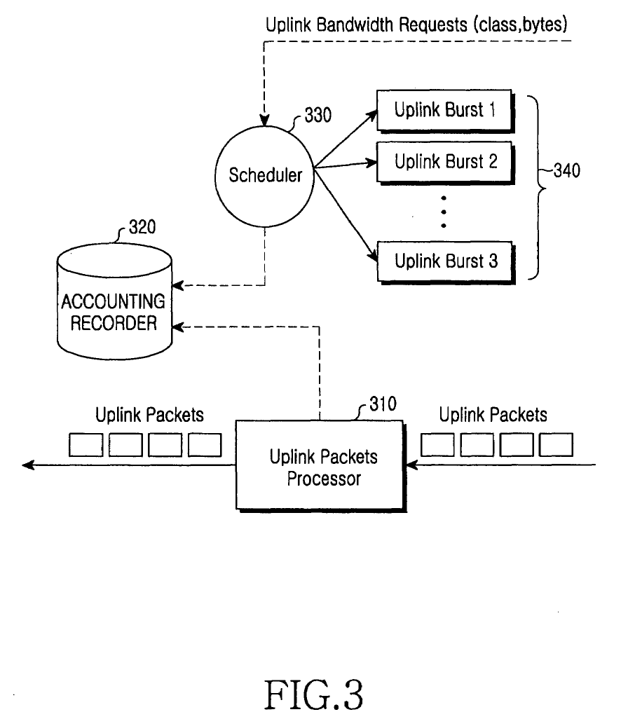

With reference to FIG. 3, a description will now be made of a BS for accounting in a communication system according to an embodiment of the present invention. FIG. 3 is a schematic diagram illustrating a structure of a BS for accounting in a communication system according to an embodiment of the present invention.

Referring to FIG. 3, the BS includes an uplink packet processor 310 for processing uplink data packets received from MSs, a scheduler 330 for broadcasting, to the MSs, uplink burst field information 340 of the MSs, corresponding to the resources that it has allocated to the MSs for transmission of uplink data packets by the MSs in response to an uplink resource request (or Uplink Bandwidth Request), and an accounting recorder 320 for recording accounting for the MSs according to the uplink data packet processing information, i.e., data packet reception information, received from the uplink packet processor 310, and the resource allocation information of the MSs received from the scheduler 330, and then transmitting the accounting records of corresponding MSs to the accounting server 240 shown in FIG. 2. The accounting recorder 320 records accounting for the MSs according to resource allocation information of the MSs and then transmits the accounting records to the accounting server 240. Alternatively, the accounting recorder 320 records accounting for the MSs according to the resource allocation information, and the uplink data packet processing information, i.e., use information of the resources used depending on an amount and a QoS class of the received uplink data packets, and then transmits the accounting records to the accounting server 240.

The scheduler 330, upon receipt of a message with uplink resource allocation request information from MSs located in a cell managed by the BS itself, allocates resources to corresponding MSs according to the uplink resource allocation request information of the MSs, included in the received message. The uplink resource allocation request information of the MSs is information by which the MSs request resource allocation to transmit uplink data packets to the BS, and this information includes an amount of uplink data packets to be transmitted to the BS by the MSs, i.e., an amount of data, and a QoS class of the uplink data packets, i.e., QoS class information of the data. The scheduler 330 allocates resources to the corresponding MSs according to the amount of data and the QoS class information of data.

Thereafter, the scheduler 330 transmits allocation information of the resources allocated to the corresponding MSs to the accounting recorder 320. The accounting recorder 320 records therein resource allocation information of the corresponding MSs, for example, frame numbers mapped to uplink burst fields of the MSs, identification information of the corresponding MSs, QoS class information of resources allocated to the corresponding MSs, and data amount information for the resources allocated to the corresponding MSs. After allocating the corresponding resources to the MSs as described above, the scheduler 330 broadcasts to the MSs the uplink burst field information 340 of the MSs, mapped to the allocated resources.

The uplink packet processor 310 processes uplink data packets received from the MSs over the uplink resources that the scheduler 330 has allocated to the MSs in response to a resource allocation request from the MSs, and transmits the processing results to its upper node, for example, the IP network 230 shown in FIG. 2. The uplink packet processor 310, every time it processes the uplink data packets received from the MSs and completes transmission of the processing results, transmits to the accounting recorder 320 and records therein, information on the transmission-completed data packets, i.e., use information of the resources that the MSs have used depending on (i) an amount of the uplink data packets received from the MSs, i.e., amount information of the data received over the resources that the scheduler 330 has allocated to the MSs, and (ii) a QoS class of the uplink data packets received from the MSs, i.e., QoS class information of the data received over the resources that the scheduler 330 has allocated to the MSs.

After recording in the accounting recorder 320 the resource allocation information of the corresponding MSs and the use information of the resources that the MSs have used depending on information on the data packets received from the corresponding MSs, the BS transmits accounting information for the corresponding MSs to the accounting server 240 according to the information recorded in the accounting recorder 320. The BS transmits the accounting information for the corresponding MSs to the accounting server 240 according to the allocation information of the resources allocated to the corresponding MSs. Alternatively, the BS transmits the accounting information for the corresponding MSs to the accounting server 240 not only according to the allocation information of the resources allocated to the corresponding MSs, but also according to the use information of the resources used by the corresponding MSs.

In the latter case, the BS compares an amount and a QoS class of the uplink data packets that corresponding MSs will transmit according to the resource allocation information received from the scheduler 330, i.e., according to the resources requested by the corresponding MSs, with an amount and a QoS class of the uplink data packets, received from the uplink packet processor 310, that the corresponding MSs have transmitted over the allocated resources.

More specifically, in the communication system according to an embodiment of the present invention, when MSs request resource allocation to transmit uplink data packets to a BS, the BS calculates a difference between an amount and a QoS class of the uplink data packets that the MSs will transmit according to the allocation-requested resources, and an amount and a QoS class of the uplink data packets that the MSs have actually transmitted over the resources that the BS has allocated according to the amount and QoS class of the uplink data packets to be transmitted. That is, the BS calculates use efficiency of the resources that it has allocated according to an amount and a QoS class of the uplink data packets that the MSs will transmit, i.e., calculates a difference between the resources allocated to the MSs and the resources that the MSs have used for transmission of the uplink data packets, and then charges the corresponding MSs according to the calculated resource difference. The BS can charge the corresponding MSs taking into account not only the calculated resource difference, but also the amount and QoS class of the uplink data packets received from the MSs.

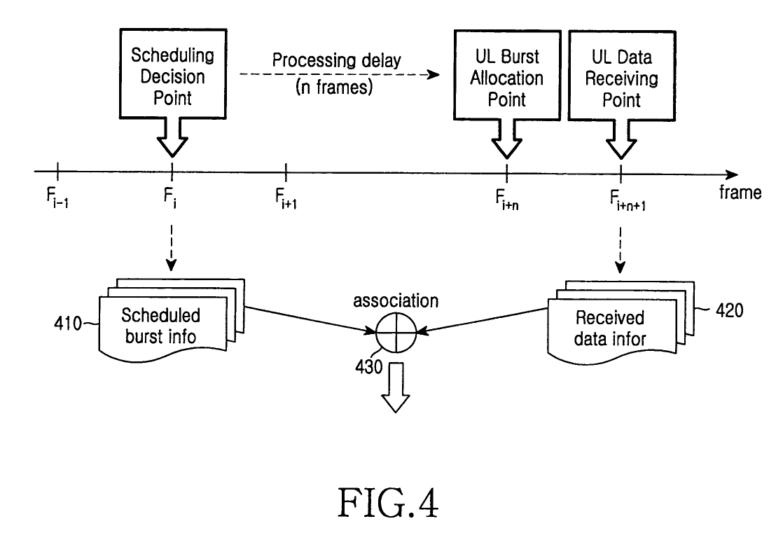

With reference to FIG. 4, a detailed description will now be made of accounting for an MS by a BS in a communication system according to an embodiment of the present invention. FIG. 4 is a diagram for a description of accounting by a BS in a communication system according to an embodiment of the present invention.

Referring to FIG. 4, the BS, upon receipt of a message with uplink resource allocation request information from MSs located its cell, allocates resources to corresponding MSs at a scheduling decision time, for example, at an i^{th} frame Fᵢ, according to the uplink resource allocation request information of MSs, included in the received message. The uplink resource allocation request information of MSs is information by which the MSs request resource allocation to transmit uplink data packets to the BS, and this information includes an amount of uplink data packets to be transmitted to the BS by the MSs, i.e., an amount of data, and a QoS class of the uplink data packets, i.e., QoS class information of the data. The BS allocates resources to the corresponding MSs according to the amount of data and the QoS class information of data.

Thereafter, the BS records, in an accounting recorder 320, allocation information 410 of the resources allocated to the corresponding MSs at the scheduling decision time Fᵢ. The resource allocation information of the corresponding MSs, recorded in the accounting recorder 320, may include frame numbers mapped to uplink burst fields of the MSs, identification information of the corresponding MSs, QoS class information of the resources allocated to the corresponding MSs, and data amount information of the resources allocated to the corresponding MSs. After allocating the corresponding resources to the MSs in this manner, the BS broadcasts uplink burst field information of the MSs, mapped to the allocated resources, to the MSs. Taking a processing delay of the communication system into account, the uplink burst field information of MSs may include information used for allowing the MSs to start transmission of uplink data packets at a transmission time of uplink data packets, for example, at an (i+n)^{th} frame Fᵢ₊ₙ. In an embodiment of the present invention, it is assumed that the communication system has an n-frame processing delay.

At the transmission time Fᵢ₊ₙ of the uplink data packets, the MSs transmit uplink data packets over the resources allocated at the scheduling decision time Fᵢ. Then the BS receives the uplink data packet from the MSs at a reception time of the uplink data packets, for example, at an (i+n+1)^{th} frame Fᵢ₊ₙ₊₁, and records, in the accounting recorder 320, reception information 420 of the received uplink data packets, for example, use information of the resources that the MSs have used to transmit uplink data packets to the BS depending on (i) an amount of uplink data packets, i.e., an amount of data that the MSs have transmitted to the BS over the resources allocated thereto, and (ii) a QoS class of the uplink data packets, i.e., a QoS class of the data that the MSs have transmitted to the BS over the resources allocated thereto.

The BS generates accounting information by combining, with use of a combiner 430, the allocation information 410 of the resources that it has allocated to the corresponding MSs at the scheduling decision time Fᵢ, recorded in the accounting recorder 320, with the use information of the resources that the corresponding MSs have used to transmit data packets depending on reception information of the data packets received, at the uplink data reception time Fᵢ₊ₙ₊₁, over the resources allocated thereto at the scheduling decision time Fᵢ, and then performs accounting on the corresponding MSs according to the generated accounting information. In this case, the BS charges a corresponding MS according to allocation information of the resources that it has allocated in response to a resource allocation request of the MS, or charges the corresponding MS not only according to the allocation information, but also according to use information of the resources that the corresponding MS has used for its data transmission to the BS over the allocated resources.

In the latter case, the BS compares an amount and a QoS class of uplink data packets that the corresponding MSs will transmit depending on resource allocation information received from the scheduler 330 at the scheduling decision time Fᵢ, i.e., depending on the resources requested by the corresponding MSs, with an amount and a QoS class of uplink data packets, received from the uplink packet processor, that the corresponding MSs have transmitted at the data reception time Fᵢ₊ₙ₊₁ over the resources allocated at the scheduling decision time Fᵢ,. In other words, in the communication system according to an embodiment of the present invention, when MSs request resource allocation to transmit uplink data packets to a BS, the BS calculates a difference between an amount and a QoS class of the uplink data packets that the corresponding MSs will transmit according to the allocation-requested resources, and an amount and a QoS class of the uplink data packets that the MSs have transmitted over the resources that the BS has allocated according to the amount and QoS class of the uplink data packets to be transmitted.

That is, the BS calculates use efficiency of the resources that it has allocated according to an amount and a QoS class of the uplink data packets that the MSs will transmit, i.e., calculates a difference between the resources allocated to the corresponding MSs and the resources that the corresponding MSs have used for transmission, and then charges the corresponding MSs according to the calculated resource difference. The BS can charge the corresponding MSs taking into account not only the calculated resource difference, but also the amount and QoS class of the uplink data packets received from the corresponding MSs. For charging the corresponding MSs, the BS can set an accounting weight for allocation information of the resources allocated to the corresponding MSs; set an accounting weight for resource use efficiency, i.e., a difference between the resources allocated to the corresponding MSs and the resources that the corresponding MSs have used for data transmission; or set an accounting weight for an amount and a QoS class of the uplink data packets received from the corresponding MSs.

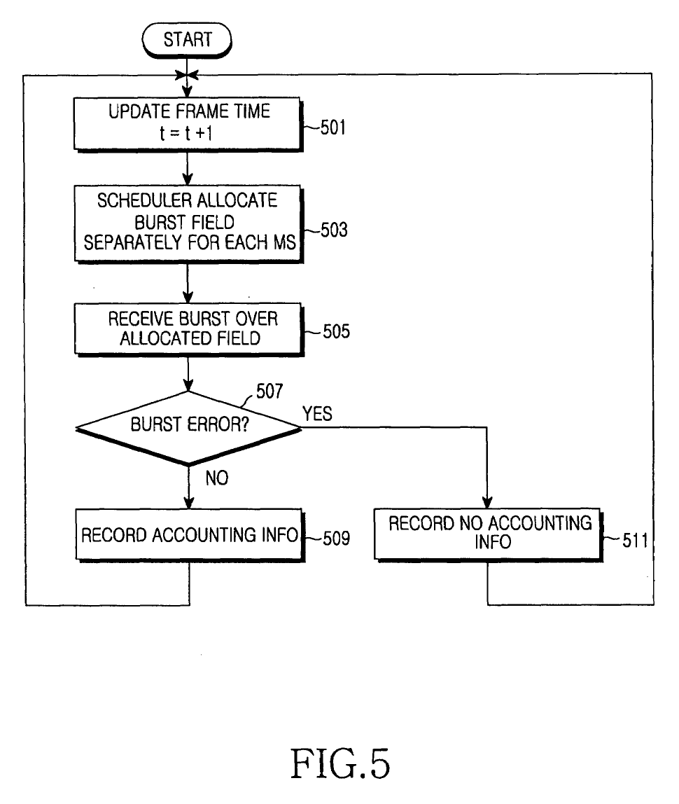

With reference to FIG. 5, a description will now be made of a process of generating accounting information by a BS in a communication system according to an embodiment of the present invention. FIG. 5 is a flowchart illustrating a process of generating accounting information by a BS in a communication system according to an embodiment of the present invention.

Referring to FIG. 5, in step 501, when the BS receives a message including uplink resource allocation request information from MSs located in its cell, the BS updates a frame time and determines a scheduling decision time depending on the uplink resource allocation request information of MSs included in the received message. The resource allocation request information is information by which the MSs request resource allocation to transmit uplink data packets to the BS, and this information includes an amount of uplink data packets to be transmitted to the BS by the MSs, i.e., an amount of data, and a QoS class of the uplink data packets, i.e., QoS class information of the data. A scheduler 330 of the BS allocates resources to the corresponding MSs according to the amount of data and the QoS class information of data.

Thereafter, in step 503, the BS allocates, by the scheduler 330, resources, i.e., burst fields, separately for the corresponding MSs according to the uplink resource allocation request information received from the MSs so that the MSs can transmit uplink data bursts at a particular frame, and then broadcasts information on the allocated burst fields to the MSs. In step 505, the BS receives data bursts from the MSs over the resources, i.e., burst fields, allocated in step 503. In step 507, the BS determines whether there is any error in the data bursts, i.e., uplink data, received from the MSs.

If it is determined in step 507 that there is an error in the received data bursts, the BS proceeds to step 511 where it records no accounting information for the corresponding MSs that have transmitted the data bursts, and then returns to step 501. However, if it is determined in step 507 that there is no error in the received data bursts, the BS records in step 509 accounting information for the corresponding MSs that have transmitted the data bursts, and then returns to step 501. The accounting information recorded in step 509 has been described in detail above. The BS charges the MSs according to the recorded accounting information.

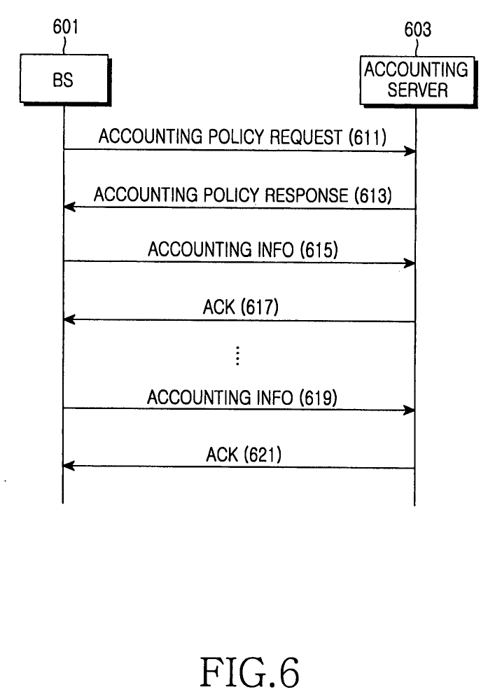

With reference to FIG. 6, a description will now be made of a signaling flow between a BS and an accounting server in a communication system according to an embodiment of the present invention. FIG. 6 is a schematic signaling diagram illustrating signal exchange between a BS and an accounting server in a communication system according to an embodiment of the present invention.

Referring to FIG. 6, a BS 601 sends to an accounting server 603 a request message for requesting information on an accounting policy for the MSs located in its cell in step 611. In response to the request message, the accounting server 603 sends to the BS 601 a response message including accounting policy information for the MSs in step 613. In step 615, the BS 601 transmits to the accounting server 603 the accounting information generated in the manner described above. The accounting server 603 sends in step 617 an Acknowledgement (ACK) message to the BS 601 in acknowledgement of the accounting information. The BS 601 and the accounting server 603 exchange the accounting information and its associated ACK message in steps 619 and 621.

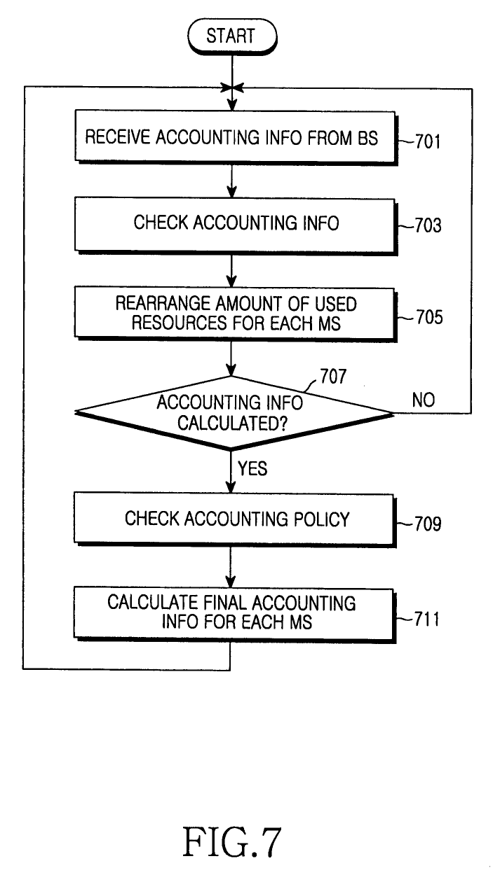

With reference to FIG. 7, a detailed description will now be made of an operation of an accounting server in a communication system according to an embodiment of the present invention. FIG. 7 is a flowchart illustrating an accounting operation of an accounting server in a communication system according to an embodiment of the present invention.

Referring to FIG. 7, in step 701, the accounting server receives accounting information, for example, the accounting information shown in Table 1, from a BS.

TABLE 1

| | | Request | | | Use | |
|---|---|---|---|---|---|---|
| | | Information | | Allocation | Information | |
| | | QoS | Request | Information | QoS | Used |
| Frame # | MS_ID | Class | Size | Grant Size | Class | Size |
| 1 | 1 | UGS | 60 bytes | 64 bytes | UGS | 59 bytes |
| | 4 | BE | 250 bytes | 264 bytes | BE | 250 bytes |
| | . . . | . . . | . . . | . . . | . . . | . . . |

In Table 1, UGS stands for Unsolicited Grant Service, and BE for Best Effort.

Upon receipt of the accounting information shown in Table 1, the accounting server checks the accounting information separately for MSs in step 703, and rearranges in step 705 an amount of used resources separately for the MSs for a particular frame, for example, rearranges requested resources, allocated resources, used resources, and a difference, or mismatch size, between allocated resources and used resources, all of which are determined depending on an amount and a QoS class of data for each of the individual MSs, as shown in Table 2.

TABLE 2

| | | | | Total | Total | Total | Total |
|---|---|---|---|---|---|---|---|
| | Start | | QoS | Request | Grant | Used | Mismatch |
| MS_ID | Frame # | End Frame # | Class | Size | Size | Size | Size |
| 1 | 1225 | 2353 | UGS | 6020 bytes | 6405 bytes | 6325 bytes | 325 bytes |
| | | | BE | 250 bytes | 264 bytes | 250 bytes | 250 bytes |
| . . . | . . . | . . . | . . . | . . . | . . . | . . . | . . . |

Thereafter, in step 707, the accounting server determines whether accounting information of corresponding MSs has been calculated. If it is determined that the accounting information of the corresponding MSs has been calculated, the accounting server proceeds to step 709 where it checks an accounting policy for the corresponding MSs. The accounting policy, to be applied to the corresponding MSs, may include flat-rate accounting, packet-based accounting, allocation-based accounting, mismatch-based accounting, and the like. The flat-rate accounting policy, a policy for applying flat-rate accounting to MSs regardless of the amount of transmitted/received data, checks flat-rate accounting selected by the corresponding MSs, using MS information, for example, MS identification information, and then charges the MSs according to the selected flat-rate accounting. The packet-based accounting policy, a policy for performing accounting according to transmitted/received data, performs accounting according to an amount and a QoS class of the transmitted/received data. The allocation-based accounting policy, when an MS requests resource allocation for data transmission/reception, performs accounting according to allocation information of the resources allocated to the MS. The mismatch-based accounting policy performs accounting according to a difference between the allocated resources and used resources.

After checking the accounting policy of the corresponding MSs, the accounting server calculates in step 711 the final accounting information for each of the individual MSs according to the checked accounting policy and the checked accounting information, and charges the MSs depending on the final accounting information. As the accounting server periodically receives accounting information of the corresponding MSs from the BS, the accounting server periodically performs the accounting operation described above.

As is apparent from the foregoing description, the present invention charges MSs according to allocation information of the resources allocated in response to requests of the MSs, or charges the MSs not only according to the allocation information but also according to use information of the resources that the MSs have used to transmit data over the allocated resources, thereby guaranteeing substantially accurate accounting for the MSs and thus improving economical utilization of the resources in the communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An accounting method in a communication system, comprising:
allocating, by a base station (BS), resources to a mobile station (MS) located in its own cell according to data that the base station will exchange with the mobile station; and
exchanging data with the mobile station over the allocated resources, and performing accounting according to allocation information of the allocated resources.

2. The accounting method of claim 1, wherein the allocation of resources comprises:
allocating resources according to amount information of the data that the base station will exchange with the mobile station.

3. The accounting method of claim 2, wherein the allocation of resources comprises:
allocating resources according to Quality-of-Service (QoS) class information of the data that the base station will exchange with the mobile station.

4. The accounting method of claim 1, wherein the performing of accounting comprises:
checking use information of resources that the mobile station has used for data exchange with the base station.

5. The accounting method of claim 4, wherein the checking of use information comprises:
checking resources used according to an amount of data that the base station has exchanged with the mobile station.

6. The accounting method of claim 5, wherein the checking of use information comprises:
checking resources used according to QoS class information of the data that the base station has exchanged with the mobile station.

7. The accounting method of claim 4, wherein the performing of accounting comprises:
performing accounting according to the allocation information and the use information.

8. The accounting method of claim 7, wherein the performing of accounting comprises:
performing accounting according to a difference between the allocated resources and the used resources.

9. The accounting method of claim 8, wherein the performing of accounting comprises:
performing accounting according to a difference between an amount of the data that the base station will exchange with the mobile station and an amount of the data that the base station has exchanged with the mobile station.

10. The accounting method of claim 9, wherein the performing of accounting comprises:
performing accounting according to a difference between a QoS class of the data that the base station will exchange with the mobile station and a QoS class of the data that the base station has exchanged with the mobile station.

11. The accounting method of claim 1, wherein the performing of accounting comprises:
performing accounting according to an accounting policy of the mobile station.

12. An accounting system in a communication system, comprising:
a base station (BS) in charge of a particular cell, for allocating resources to a mobile station (MS) located in the cell according to data that the base station will exchange with the mobile station, exchanging data with the mobile station over the allocated resources, and then performing accounting according to allocation information of the allocated resources.

13. The accounting system of claim 12, wherein the base station allocates resources according to amount information of the data that the base station will exchange with the mobile station.

14. The accounting system of claim 13, wherein the base station allocates resources according to Quality-of-Service (QoS) class information of the data that the base station will exchange with the mobile station.

15. The accounting system of claim 12, wherein the base station checks use information of resources that the mobile station has used for data exchange with the base station.

16. The accounting system of claim 15, wherein the base station checks resources used according to an amount of data that the base station has exchanged with the mobile station.

17. The accounting system of claim 16, wherein the base station checks resources used according to QoS class information of the data that the base station has exchanged with the mobile station.

18. The accounting system of claim 15, wherein the base station performs accounting according to the allocation information and the use information.

19. The accounting system of claim 18, wherein the base station performs accounting according to a difference between the allocated resources and the used resources.

20. The accounting system of claim 19, wherein the base station performs accounting according to a difference between an amount of the data that the base station will exchange with the mobile station and an amount of the data that the base station has exchanged with the mobile station.

21. The accounting system of claim 20, wherein the base station performs accounting according to a difference between a QoS class of the data that the base station will exchange with the mobile station and a QoS class of the data that the base station has exchanged with the mobile station.

22. The accounting system of claim 12, wherein the base station performs accounting according to an accounting policy of the mobile station.

23. An accounting system in a communication system, comprising:
a mobile station;
a base station (BS) capable of communicating with the mobile stations;
wherein the base station includes:
a scheduler for allocating resources to the mobile station according to an amount and a quality-of-service (QoS) class according to data that the base station will exchange with the mobile station;
a data processor for processing the data that the base station will exchange with the mobile station and data that the base station has exchanged with the mobile station through the allocated resources;
an accounting part for accounting according to process of the scheduler and the data processor.

24. The accounting system of claim 23, wherein the accounting part performs accounting based on the amount of the data that the base station will exchange with the mobile station.

25. The accounting system of claim 24, wherein the accounting part performs accounting based on the QoS class the data that the base station will exchange with the mobile station.

26. The accounting system of claim 23, wherein the accounting part performs accounting based on the amount of the data that the base station has exchanged with the mobile station through the allocated resources.

27. The accounting system of claim 26, wherein the accounting part performs accounting based on the QoS class of the data that the base station has exchanged with the mobile station through the allocated resources associated with the data actually received from the first mobile station.
